(19) United States
(12) Patent Application Publication
(10) Pub. No.: US 2010/0089456 A1
(43) Pub. Date: Apr. 15, 2010

(54) METHOD AND APPARATUS FOR LOW POWERED AND/OR HIGH PRESSURE FLOW CONTROL

(75) Inventor: Patrick A. LOWERY, Greer, SC (US)

Correspondence Address: MCNEES WALLACE & NURICK LLC, 100 PINE STREET, P.O. BOX 1166, HARRISBURG, PA, 17108-1166, US

(73) Assignee: CIRCOR INSTRUMENTATION TECHNOLOGIES, INC., Spartanburg, SC (US)

(21) Appl. No.: 12/578,288

(22) Filed: Oct. 13, 2009

Related U.S. Application Data
(60) Provisional application No. 61/105,309, filed on Oct. 14, 2008.

(51) Int. Cl. G05D 7/00; F16K 7/00

(52) U.S. Cl. 137/1; 137/14; 137/486

(57) ABSTRACT

The present invention relates to a fluid control system for regulating a fluid. A control device positionable between an inlet and outlet includes a first bellows, a second bellows, a resilient member, a diaphragm and a valve. The diaphragm and valve is each in fluid communication with the inlet and outlet, the valve movable between a closed position and an open position. An adjustment feature is associated with adjusting a force applied by at least one of the first bellows and the second bellows, adjustment of the adjustment feature not requiring disassembly of the control device. In response to a predetermined fluid force applied against the diaphragm by the regulated fluid flowing from the inlet toward the outlet, the first bellows, the second bellows and the resilient member apply a combination of opposed forces to selectably move the valve toward a position for regulating the regulated fluid.

### FIELD OF THE INVENTION

The present invention relates generally to fluid flow systems and, more particularly, to monitoring performance of components of fluid flow systems.

### BACKGROUND OF THE INVENTION

Many industrial applications require monitoring of fluid flows. Some applications involve monitoring flows of highly flammable fluids, such as hydrogen vapor, requiring fail safe control systems configured to be incapable of causing an ignition event during operation of the control system. As a consequence, components of the control system must either operate at extremely low power levels, or must be encased in a vessel capable of containing an explosion, among other operating restrictions. Such encased components require considerable space, which is undesirable in close quartered applications, and are costly. In addition, current control system components compatible with low power requirements are restricted to low pressure levels, or do not operate with sufficient precision.

Thus, there is a need for control systems configured for use in an intrinsic safety environment and for control systems configured for use in high pressures and/or flow rates.

### SUMMARY OF THE INVENTION

The present invention relates to a fluid control system for regulating a fluid including a body having a first inlet and a first outlet in fluid communication. A control device positionable between the first inlet and the first outlet includes a first bellows, a second bellows, a first resilient member, a diaphragm and a valve. The diaphragm and the valve is each in selectable fluid communication with the first inlet and the first outlet, the valve movable between a closed position and an open position in which the open position permitting fluid communication between the first inlet and the first outlet. The diaphragm is in fluid communication with the second bellows. An adjustment feature is associated with adjusting a force applied by at least one of the first bellows and the second bellows. Adjustment of the adjustment feature does not require disassembly of the control device. In response to a predetermined fluid force applied against the diaphragm by the regulated fluid flowing from the first inlet toward the first outlet, the first bellows, the second bellows and the first resilient member applying a combination of opposed forces to selectably move the valve toward a position for regulating the regulated fluid.

The present invention further relates to a method for regulating a fluid flowing from an inlet toward an outlet in a fluid control system, the steps include providing a control device positionable between the inlet and the outlet including a first bellows, a second bellows, a first resilient member, a diaphragm and a valve. The diaphragm and the valve is each in selectable fluid communication with the first inlet and the first outlet, the valve movable between a closed position and an open position in which the open position permitting fluid communication between the first inlet and the first outlet. The diaphragm is in fluid communication with the second bellows. The method further includes adjusting an adjustment feature associated with adjusting a force applied by at least one of the first bellows and the second bellows, wherein adjustment of the adjustment feature not requiring disassembly of the control device. The method further includes positioning the first bellows, the second bellows and the first resilient member so as to apply a combination of opposed forces to selectably move the valve toward a position for regulating the fluid in response to the fluid applying a predetermined fluid force against the diaphragm.

The present invention still further relates to a fluid control system for regulating a fluid including a body having an inlet and an outlet in fluid communication. A control device is disposed between the inlet and the outlet including a first bellows, a second bellows, a first resilient member, a diaphragm and a valve. The diaphragm and the valve is each in selectable fluid communication with the first inlet and the first outlet, the valve movable between a closed position and an open position in which the open position permitting fluid communication between the first inlet and the first outlet. The diaphragm is in fluid communication with the second bellows. An adjustment feature is associated with adjusting a force applied by at least one of the first bellows and the second bellows, the adjustment feature taken from the group consisting of an adjustable threaded connection and a pressurized fluid source, wherein adjustment of the adjustment feature not requiring disassembly of the control device. In response to a predetermined fluid force applied against the diaphragm by the regulated fluid and flowing from the inlet toward the outlet, the first bellows, the second bellows and the first resilient member applying a combination of opposed forces to selectably move the valve toward a position for regulating the regulated fluid.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a schematic view of an embodiment of a portion of a fluid control system of the present disclosure.

FIG. 2 is a schematic view of an embodiment of a portion of a fluid control system for regulating multiple fluids of the present disclosure.

FIGS. 3-5 are schematic views of alternate embodiments of a portion of a fluid system of the present disclosure.

FIGS. 6A and 6B are a cross section and an exploded cross section, respectively, of an embodiment of a control device of a fluid control system of the present disclosure.

FIGS. 7-9 are cross sections of alternate embodiments of control devices of fluid control systems of the present disclosure.

FIG. 10 is a graphical representation of a “droop curve” for a fluid control system.

FIGS. 11A and 11B are cross sections of alternate embodiments of a control device of a fluid control system of the present disclosure.

FIG. 12 is a cross section of an alternate embodiment of a control device of a fluid control system of the present disclosure.

FIG. 13 is a plan view of an embodiment of a sensor of a control device of a fluid control system of the present disclosure.

FIGS. 14-16 are graphical representations of flow rate as sensed by a flow sensor (FIG. 14) compared to that from a strain piezo-film sensor to obtain improved response for flow rate for a fluid system of the present disclosure.

Wherever possible, the same reference numbers will be used throughout the drawings to refer to the same or like parts.

### DETAILED DESCRIPTION OF THE INVENTION

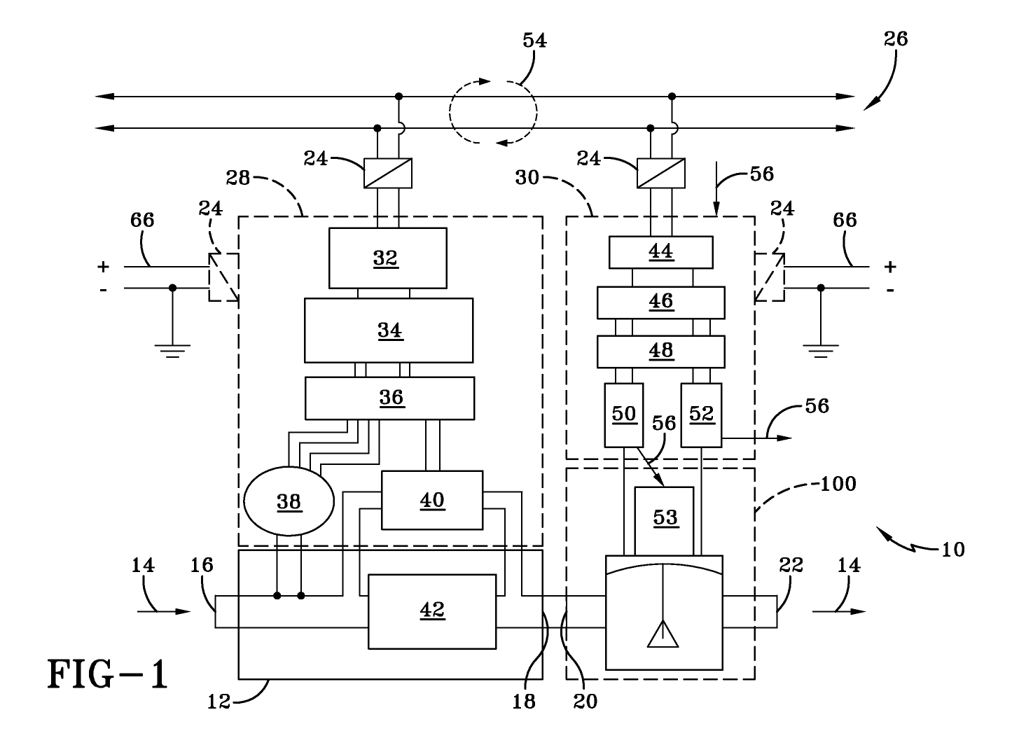

Referring now to the drawings, FIG. 1 shows a schematic view of a portion of a fluid control system 10, such as for use in regulating a fluid 14. Fluid control system 10 includes a body 12 having an inlet 16 and an outlet 18 in fluid communication for receiving fluid 14 therethrough. As further shown in FIG. 1, an in-line sensor 42 may be used to monitor at least one parameter of fluid 14. While not intended to be limiting, sensor 42 may include a thermal bypass linear flow element (LFE), differential pressure (DP) flow restriction, porous element or other device. Alternately, or in addition to sensor 42, a sensor 38, such as a pressure or temperature sensor, or a sensor 40, such as a thermal mass sensor or differential pressure sensor may be used. In one embodiment, sensors such as pressure and/or temperature sensors may be combined into a single device.

As further shown in FIG. 1, body 12 is associated with a module 28. Module 28 may be electrically connected to body 12 and sensors 36, 38, 40 while being located remotely from body 12. Alternately, module 28 may contain body 12 and sensors 36, 38, 40 positioned within a single enclosure. Module 28, which is in electrical communication with a bus 26, includes a bus interface 32. In one embodiment, bus interface 32 further operates to communicate with energy limiting circuitry 36. Such energy limiting circuitry 36 is configured for use as part of an intrinsic safety environment, and may also include energy containment circuitry. The components of an intrinsic safety environment are configured to be incapable of causing an ignition event during operation of the control system, even when the components malfunction. Components often associated with fluid control systems, such as solenoids and piezo valves, cannot be used in intrinsic safety environments, at least not unless they are placed within an explosion-proof vessel, which adds complexity, cost and significantly increased size requirements, rendering such designs unworkable for many industrial applications. Intrinsic safety environment circuitry is further disclosed in Applicant's copending U.S. patent application Ser. No. ______ titled CONTROL SYSTEM and is incorporated by reference herein in its entirety.

While the present invention may be configured for use with an intrinsic safety environment, it is not so limited.

It is to be understood that the term electrical communication is not limited to providing electrical power, but further includes the capacity for data communication with the bus and other electrical devices.

As further shown in FIG. 1, bus interface 32 is in electrical communication with controller 34 and may include sensor signal acquisition from sensors 38, 40, 42 and may further contain memory circuitry for use with energy limiting circuitry 36. Controller 34 may be a microcontroller or other component known in the art. While bus interface 32 and other components of module 28 may receive electrical power from bus 26, electrical power may alternately be provided or may be available from an electrical source 66, such as in case of discontinued electrical power from bus 26.

A control device 100 is configured to regulate fluid 14 for fluid control system 10. Control device 100 includes an inlet 20 and an outlet 22 in fluid communication for receiving fluid 14 therethrough. In one embodiment, in which body 12 and control device 100 are combined in a single housing, inlet 16 of body 12 and inlet 20 can be the same. Similarly, outlet 18 of body 12 and outlet 22 of control device 100 can also be the same. Alternately, portions of body 12 and control device 100 may be positioned so that at least one of inlet 16 and inlet 20 or outlet 18 and outlet 22 can be remotely located from each other. Such alternate arrangements could include any combination of sensors 38, 40, 42 positioned in close proximity or remotely from control device 100.

A module 30 includes components configured to provide one form of an force adjustment feature, which will be described in additional detail below, to control device 100. Module 30 includes a bus interface 44 that is in electrical communication with bus 26 and functions in a similar manner as bus interface 32 of module 28. Alternately, bus interface 44 may also include a communications co-processor for use with bus 26. A controller 46 is in electrical communication with bus interface 44 and includes valve drivers, such as a linear valve driver configured to operate using pulse width modulation and optional power conditioning circuitry 48, such as previously discussed with module 28. Whether power conditioning circuitry 48 is employed, which may be used to control solenoids and piezo-resistive devices, controller 46 selectably drives a pressurization valve 50 and a de-pressurization valve 52 that controls the magnitude of a pressurized fluid 56 provided from a pressurized fluid source (not shown) to control device 100. In one embodiment, valves 50, 52 may be solenoids and/or piezo-resistive devices.

While bus interface 44 and other components of module 30 may receive electrical power from bus 26, electrical power may alternately be provided or may be available from an electrical source 66, such as in case of discontinued electrical power from bus 26.

As shown in FIG. 1, module 30 includes a galvanic isolator 24 positioned at the interface between module 30 and electrical source 66. As used herein, a galvanic isolator is a device that may be placed between an interface between a component and an electrical source (positionable within, exterior of, or protruding from the component), which isolator being configured to sufficiently isolate electrical current to the extent that ignition cannot occur, such as for use in an intrinsic safety environment. Similarly, galvanic isolators 24 may be shown in other figures and positioned between other components, but are not limited to being positioned between the components as shown. Since the galvanic isolators serve a similar purpose in other the figures, they will not be discussed in further detail.

As further shown in FIG. 1, bus 26 can be a two wire digital bus, such as a differential CANBus, Serial (RS485) interface, digital encoding formats, such as Manchester Encoding, although other forms or combinations of forms may also be provided. In one embodiment, power and signals for bus 26 may be transmitted along the same two wires.

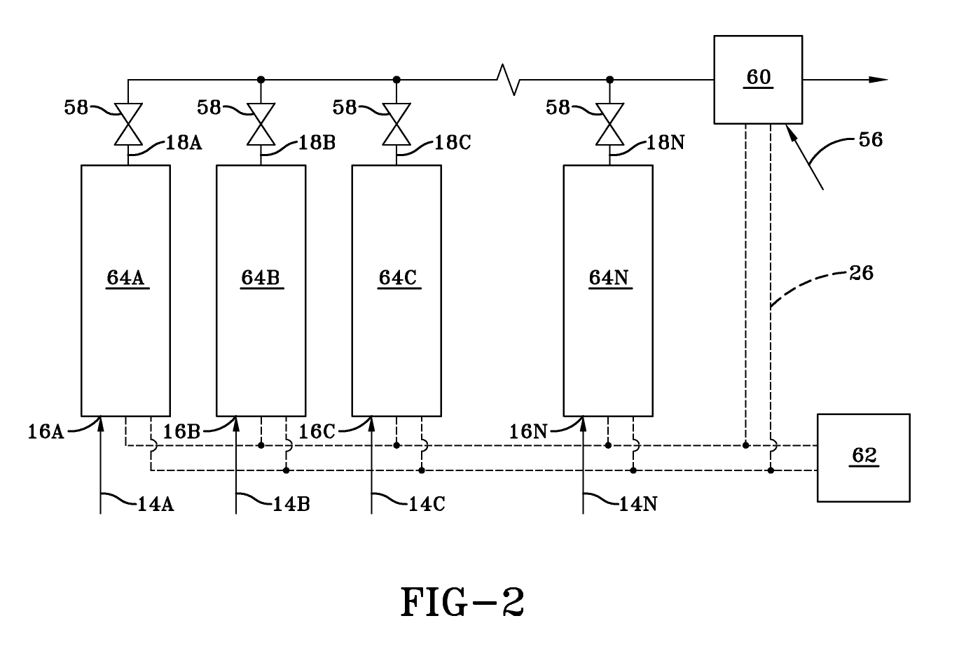

Bus 26 may include a control loop 54, employing a control algorithm, such as a proportional, integral and derivative (PID) loop or combinations of a PID, feed forwarding, or model predictive algorithms that are well known in the art and will not be further discussed herein. The control algorithm can be used with a setpoint provided by an electronics controller 62 (FIG. 2), also referred to as a bus master, and other components to effect control of the fluid control system. In other words, regulated fluid 14 may be regulated with respect to either mass flow rate or volumetric flow rate, upstream or downstream gauge/absolute pressure, differential pressure, concentrations of certain constituents within fluid 14, optical qualities of fluid 14, as in waste water management, or other means of regulating parameters of fluid 14. In one embodiment, control device 100, modules 28, 30, and body 12 may be integrated into a single unit or selectably located remotely from each other. That is, any combination of control device 100, modules 28, 30, and body 12 may be located together or located remotely from each other.

FIG. 2 schematically shows an embodiment in which respective multiple meters 64A through 64N or sensors sense a fluid parameter to be regulated for respective fluid(s) 14A through 14N entering respective inlets 16A through 16N and exiting respective outlets 18A through 18N. Electronics controller 62, via bus 26, controls valves 58 associated with each of meters 64A through 64N or sensors to regulate the amount of amount of fluid(s) 14A through 14N provided to a valve 60. In one embodiment, fluids 14A through 14N may be a single fluid, although each of fluids 14A through 14N may be a different fluid. An arrangement as shown or similar to FIG. 2 permits a single manifold outlet, i.e., between valves 58 and valve 60 and controlled by a single valve 60, providing cost savings, while providing the selective control for multiple fluids or fluid inputs to form a desired mix of fluids 14A through 14N. In one embodiment, valve 60 may be a digitally controlled pneumatic control valve, in which forces generated by valve 60 for effecting regulation of fluid(s) 14A through 14N are provided by a pressurized fluid 56 from a pressurized fluid source (not shown). A pneumatic control valve may be used in an intrinsically safe environment, if desired, and when properly sized, can be configured for use to regulate high pressure fluids, including high pressure fluids at high flow rates.

A nonlimiting list of applications usable with the arrangement of FIG. 2 include: multi-fluid or sampling analytical instruments; semiconductor chip manufacturing equipment; multi-fluid dispensing systems for food/beverage or biotechnology/biopharmaceutical applications; and chemical reactors.

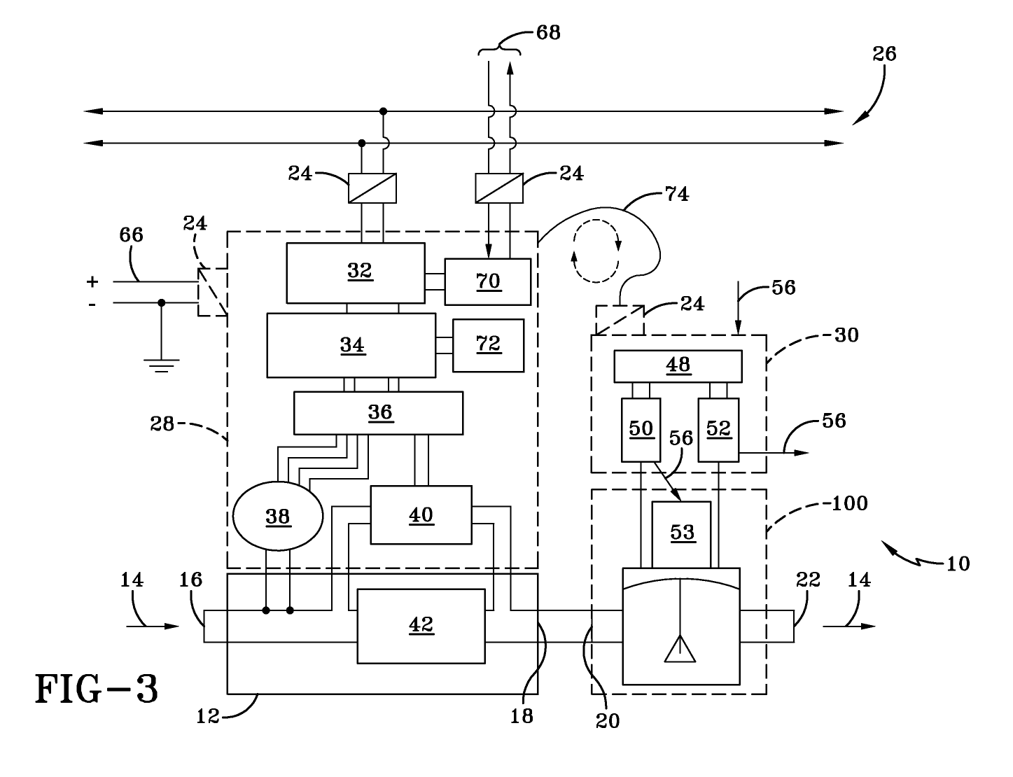

FIG. 3 shows an alternate embodiment of the fluid control system similar to that shown in FIG. 1, except that module 28 includes an optional analog I/O device 70 and associated electronics in electrical communication with bus interface 32. Analog I/O device 70 is capable of receiving electrical signals 68 provided via bus 26 to regulate fluid 14, such as to set a flow rate. An optional controller 72, similar to controller 46 of FIG. 1 that is associated with module 30, includes valve drivers, such as a linear valve driver configured to operate using pulse width modulation and optional power conditioning circuitry 36, as previously discussed with module 28. However, unlike FIG. 1, controller 72 is in electrical communication with controller 34.

As further shown in FIG. 3, an electrical cable 74 is provided in electrical communication between modules 28 and 30, providing an analog signal therebetween, as module 30 lacks electrical communication with bus 26. Electrical cable 74 can be configured for use in an intrinsically safe environment, i.e., operating at less than or equal to five volts (low voltage). However, if electrical cable 74 is configured for use in an intrinsically safe environment, the length of electrical cable 74 is generally limited to about five meters, requiring relative proximity between modules 28 and 30.

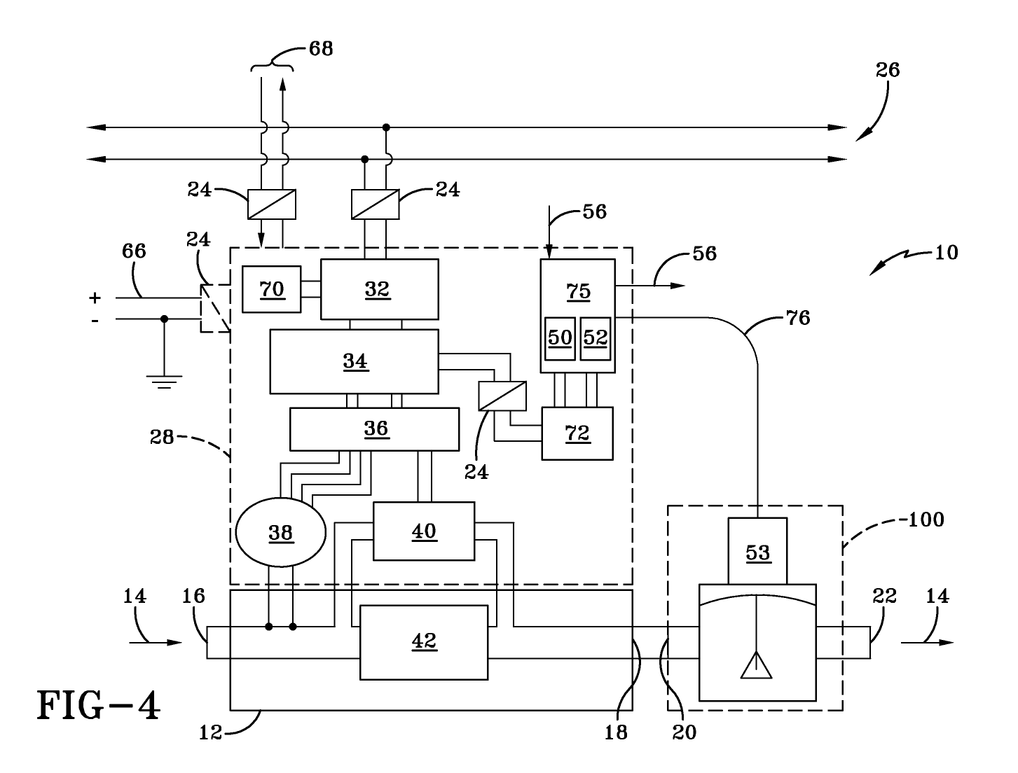

FIG. 4 shows an alternate embodiment of the fluid control system similar to that shown in FIG. 3, except that module 28 combines components formerly included with module 30. More specifically, electrical cable 74 and optional energy limiting/containment circuitry 48 in FIG. 3 are removed, and a manifold 75 is added for use with valves 50, 52 to selectively provide pressurized fluid 56 to a fluid line 76 to control device 100, venting pressurized fluid 56 as required to reduce the magnitude of fluid pressure in fluid line 76 as required to effect control of control device 100. While in one embodiment, valves 50, 52 may be solenoids and/or piezo-resistive devices, in another embodiment, valves 50, 52 may be on/off servo valves or one valve being an on/off valve and the other valve being a proportional valve. However, other valve arrangements may be used.

Control device 100 may be placed at any position with respect to module 28, i.e., upstream, downstream or otherwise remotely from module 28. The cross sectional area of fluid line 76 line can vary, with a smaller cross sectional area providing increased operational sensitivity, but resulting in a slower response by control device 100. In contrast, a larger cross sectional area of fluid line 76 line provides decreased operational sensitivity, but results in a faster response by control device 100.

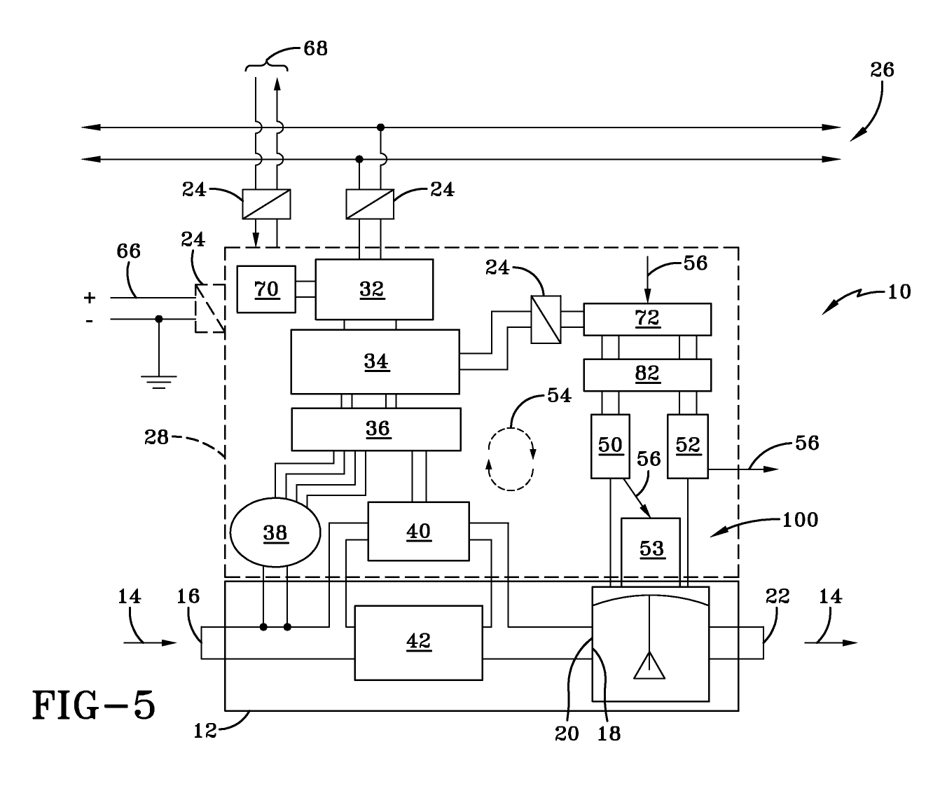

FIG. 5 shows an alternate embodiment of the fluid control system having the bus control loop of FIG. 1, by virtue of an internal electrical communication between controllers 34 and 72, with optional analog signals 68 provided to analog I/O device 70, similar to FIG. 3. However, in contrast to FIGS. 1 and 3, the arrangement of FIG. 5 shows module 28, control device 100 and body 12 contained in a single housing.

Therefore, as shown in exemplary embodiments represented by FIGS. 1 and 3-5, fluid control system 10 is extremely versatile, providing flexibility to permit use with many diverse industrial applications.

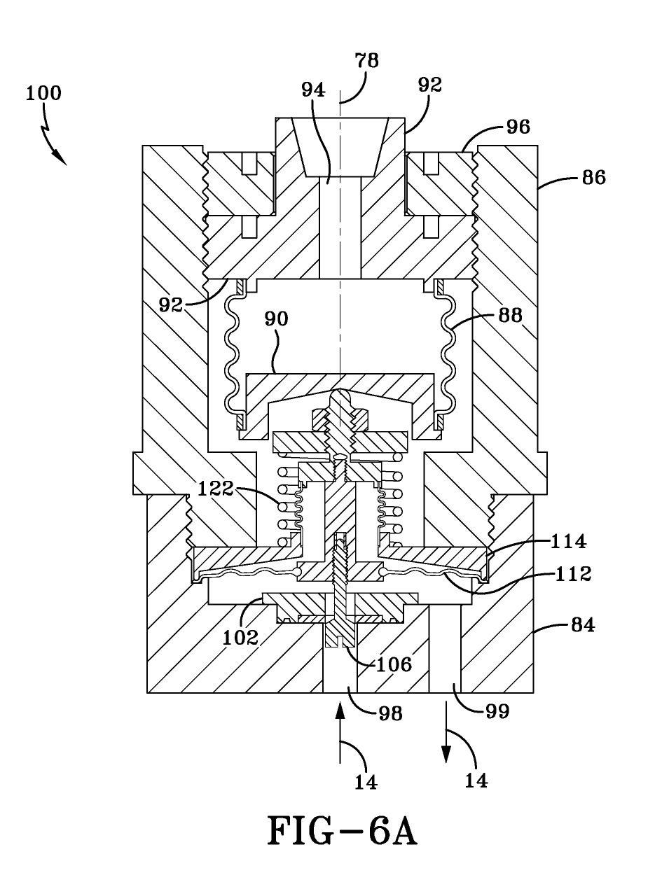

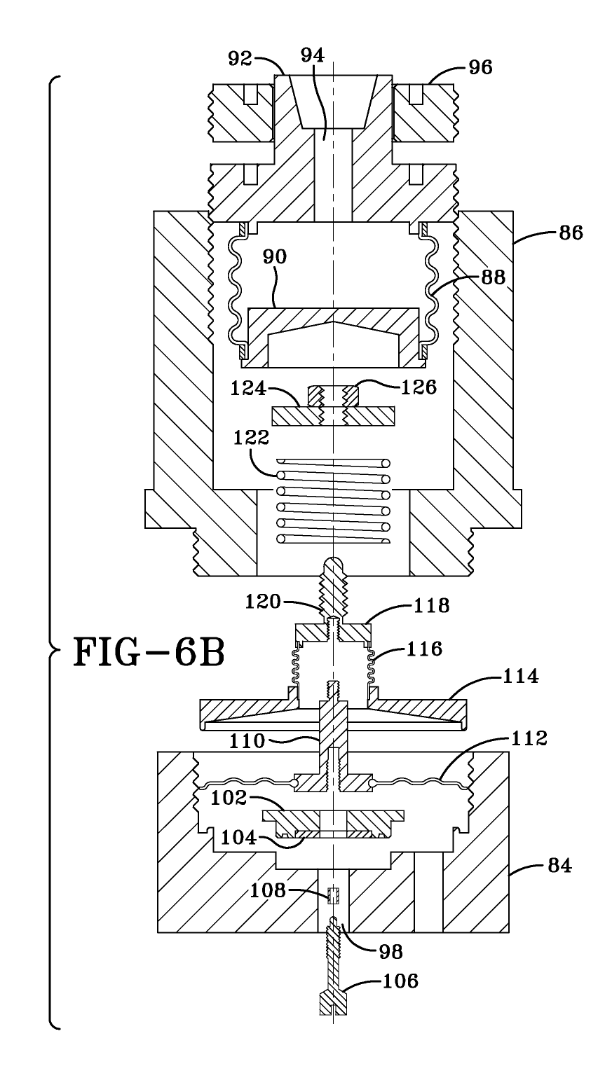

As shown in FIGS. 6A and 6B, control device 100 includes a valve body 84 and a valve housing 86 configured to be selectably joined together, such as by threaded engagement. A bellows 88, also configured and referred to as an actuation bellows, is connected at one end to a base 92 that is adjustably connectable to valve housing 86, such as by threaded engagement. A locknut 96 may be used to lock the position of base 92 with respect to valve housing 86. Bellows 88 may be edge welded, hydroformed or constructed by other techniques. An end of bellows 88 opposite base 92 is connected to a piston 90. A passageway 94 is formed through base 92 to permit connection with a pressurized fluid source that may be used to adjust the amount of force applied by piston 90.

As further shown by FIGS. 6A and 6B, a piston 110 is connected to a diaphragm 112 at one end of piston 110, such as by welding or other technique. Diaphragm 112 may be constructed of corrugated metal or other suitable flexible material which may include non-metal materials in alternate embodiment. An end of piston 110 proximate to diaphragm 112 is configured to receive a valve 106, also referred to as a poppet, and a retainer 108 is configured to retain the relative position of valve 106 installed in piston 110. A compression nut 102 is configured to receive a seat 104, with compression nut 102 being secured in valve body 84 such that valve 106 is selectably movable along an inlet 98 of valve body 84 and into and out of contact with seat 104. That is, when valve 106 is not in contact with seat 104, inlet 98 of valve body 84 is in fluid communication with an outlet 99 of valve body 84, permitting fluid 14 to flow between inlet 98 and outlet 99.

An annular collet 114 is connected, such as by previously described techniques, to one end of a bellows 116, also configured and referred to as an isolation bellows. The other end of bellows 116 is connected to a base 118, with base 118 including a stem 120 extending away from bellows 116. A resilient device 122, such as a helical spring, is slid over stem 120, surrounding bellows 116, and disposed between collet 114 and an adjustment member 124 that is movably adjusted with respect to stem 120, such as by threaded engagement. Upon actuating adjustment member 124 so that adjustment member 124 is directed to move toward collet 114, resilient device 122 is compressed between adjustment member 124 and collet 114. In response, resilient device 122 subjects bellows 116 to a pre-tension force. A locknut 126 may be used to lock the position of adjustment member 124 with respect to collet 114.

To assemble control device 100, once nut 102 (and seat 104) has been secured in valve body 84, diaphragm 112 is inserted in the opening of valve body 84 over nut 102, and then collet 114 is inserted in the opening of valve body 84 over diaphragm 112. Bringing valve body 84 and valve housing 86 together compress the collective peripheries of collet 114 and diaphragm 112 together, providing a fluid tight seal therebetween. Resilient device 122 is then compressed between adjustment member 124 and collet 114 by actuation of adjustment member 124 with respect to stem 120 as previously discussed. Once resilient device 122 has been compressed, bellows 88 is inserted in valve housing 86 by actuating base 92 with respect to valve housing 86. Upon insertion and securing of bellows 88, stem 120 abuts piston 90.

Optionally, an O-ring (not shown) composed of a polymeric material may be positioned between valve body 84 and diaphragm 112 prior to assembly. In yet another embodiment, if diaphragm 112 is composed of a metal, the periphery of diaphragm 112 could be welded to the corresponding region of valve body 84 to form the fluid tight seal. That is, depending upon the materials and components used, the resulting seal between diaphragm 112 and valve body 84 could be a metal-to-metal seal (due to compressive forces between the diaphragm 112 and valve body 84, or by welding the diaphragm and the valve body together) or a metal-to-polymeric seal when an O-ring is used.

As further shown in FIG. 6A, each of bellows 88 and 116 and valve 106 are aligned with a common centered axis 78. By virtue of pressurized fluid introduced through passageway 94 into a chamber defined by bellows 88, base 92 and piston 90 (“the bellows 88 chamber”), as well as any force contributions of bellows 88 acting as a compressed spring, a force is directed along axis 78 toward valve body 84 by piston 90. The magnitude of the force due to the pressurized fluid in the bellows 88 chamber is the magnitude of the pressure in the bellows 88 chamber multiplied by the effective area of bellows 88. The force contribution of bellows 88 acting as a compressed spring can be calculated by application of Hooke's Law (F=k*x), in which the force F equals the measured extent of elastic elongation or compression (“x”) of bellows 88 from a non-loaded length multiplied by a spring constant (“k”) associated with bellows 88. For purposes of discussion, these forces are collectively referred to as the force associated with bellows 88, or bellows 88 force. Due to piston 90 abutting stem 120, the bellows 88 force is directed along and reacted by opposed forces generated along stem 120.

A compressed resilient member 122 generates an opposed force to that of the bellows 88 force and is directed along axis 78 via stem 120. For purposes of discussion, this opposed force is referred to as the force associated with resilient member 122, or the resilient member 122 force. A second opposed force to that of the bellows 88 force is generated along axis 78 due to pressurized fluid introduced into a chamber defined by bellows 116, base 118 and diaphragm 112 (“the bellows 116 chamber”), as well as any contributions of bellows 116 acting as a compressed spring. The magnitude of the force generated by the pressurized fluid in the bellows 116 chamber and applied along stem 120 is the magnitude of the pressure in the bellows 116 chamber multiplied by the effective area of bellows 116. The force contribution of bellows 116 acting as a compressed spring can be calculated by application of Hooke's Law (F=k*x), in which the force F equals the measured extent of elastic elongation or compression (“x”) of bellows 116 from a non-loaded length multiplied by a spring constant (“k”) associated with bellows 116. In addition to the force applied along stem 120 associated with bellows 116, the magnitude of the pressurized fluid in the bellows 116 chamber multiplied by the effective area of diaphragm 112 results in a force directed to deform the diaphragm to move toward valve body 84, resisted by the spring constant associated with diaphragm 112, as is known in the art and not further discussed herein. For purposes of discussion, these forces are collectively referred to as the force associated with bellows 116, or bellows 116 force.

When the bellows 88 force is greater than the sum of the bellows 116 force, the resilient member 122 force and fluid 14 force applied against diaphragm 112, piston 90 moves along axis 78 toward valve body 84. By virtue of the abutting contact with stem 120, stem 120, simultaneously moves with piston 90. Due to their interconnection with stem 120, base 118, piston 110 and valve 106 collectively move in unison with stem 120. Movement of valve 106 away from seat 104 represents an open position of valve 106, permitting flow of fluid 14 between inlet 98 and outlet 99 of valve body 84. Conversely, when valve 106 is in abutting contact with seat 104, valve 106 is in a closed position, preventing flow of fluid 14 between inlet 98 and outlet 99 of valve body 84. Valve 106 is in a closed position when the bellows 88 force is less than the sum of the bellows 116 force, the resilient member 122 force and fluid 14 force applied against diaphragm 112, so that piston 90 moves along axis 78 away from valve body 84, permitting valve 106 to move toward the closed position.

While FIGS. 6A and 6B are configured for bellows 88 and 116 and valve 106 to actuate along a centered axis 78, the present invention is not so limited. That is, none of bellows 88 and 116 and valve 106 are required to operate in a mutually aligned arrangement to achieve opposed forces, as levers or other constructions may be used by those having ordinary skill in the art to provide nonaligned arrangements of these components. In other words, “opposed” in the context of opposed forces is defined as forces associated with the operation of the bellows and resilient member being directed so as to counteract each other to effect movement of a valve between an open position and a closed position.

It is also to be understood that while the two sets of bellows 88, 116 are opposed to each other in the exemplary embodiment, the two sets of bellows may work together, being opposed by a resilient member. In other words, embodiments of the control device may be configured such that any combination of the two bellows and resilient member can work together, i.e., apply forces to selectably move a valve in one direction, so long as at least one component (bellows or resilient member) works against the other components, i.e., apply forces to counteract selectable movement of the valve in the one direction as directed by the other components. More than one resilient member and more than two bellows may be used, if desired.

Control device 100 includes a novel adjustment feature not previously available in known art control devices, i.e., permitting custom fine-tuned adjustments to the flow control device without requiring disassembly of the flow control device. In other words, unique adjustments to each assembled control device can easily be made without concern over manufacturing tolerances that could otherwise affect the operation of an assembled control device construction, requiring repeated assembly/disassembly, e.g., to install shims, to achieve acceptable performance.

For example, in one embodiment, pressurized fluid may be selectably introduced into or selectably removed from the bellows 88 chamber. In a further embodiment, pressurized fluid may be selectably introduced into or selectably removed from the bellows 116 chamber, or both the bellows 88 chamber and the bellows 116 chamber. By virtue of the adjustment feature of pressurized fluid, the forces associated with either bellows can be adjusted, thereby providing a control device with the ability to control a fluid system operating under different conditions (e.g., pressure) without replacing the control device.

As shown in FIG. 7, control device 200 is similar to control device 100 with the exception that resilient member 122 and valve 106 are removed. The valve for control device 200 is achieved by formulation of a raised edge 80 in compression nut 102. A seat 130 is incorporated into one end of a piston 128. In other words, in response to the bellows 88 force being greater than the sum of the bellows 116 force, the resilient member 122 force and fluid 14 force applied against diaphragm 112, piston 90 moves along axis 78 toward valve body 84. By virtue of the abutting contact with stem 120, stem 120 simultaneously moves with piston 90. Due to their interconnection with stem 120, base 118 and piston 128 collectively move in unison with stem 120. Movement of seat 130 into contact with raised edge 80 represents a closed position, preventing flow of fluid 14 between inlet 98 of valve body 84 and outlet 99 of valve body 84. Conversely, an open position is represented when seat 130 is not in abutting contact with raised edge 80, permitting flow of fluid 14 between inlet 98 of valve body 84 and outlet 99 of valve body 84. The open position occurs when the bellows 88 force is less than the sum of the bellows 116 force, the resilient member 122 force and fluid 14 force applied against diaphragm 112. Stated another way, if there is sufficient fluid pressure associated with outlet 99, the fluid pressure acting against diaphragm 112 would move piston 128 away from raised edge 80, resulting in an open position until the outlet fluid pressure sufficiently abates, permitting the closed position to be achieved.

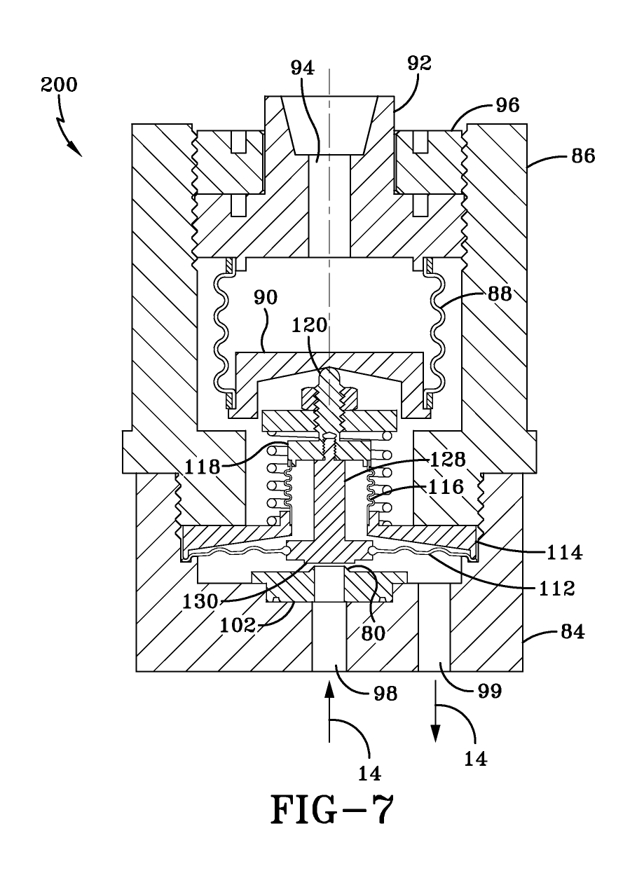

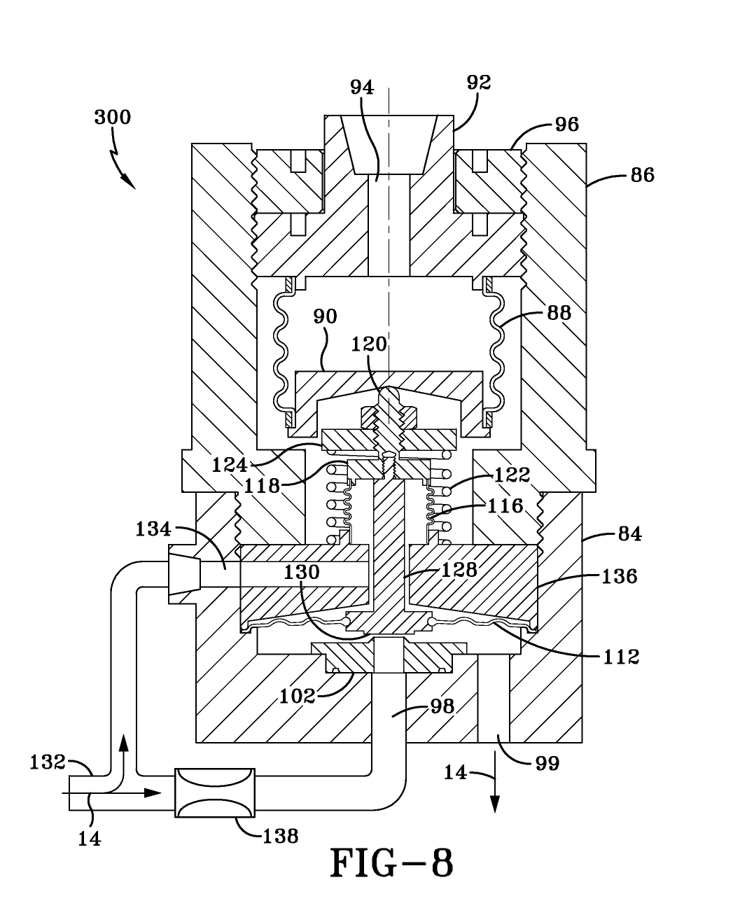

FIG. 8 shows a construction of control device 300 that is similar to control device 200 except as discussed. One difference is a passageway 134 formed in a collet 136, otherwise similar to collet 114. A regulating device 138 is disposed upstream of control device 300 between inlet 98 of valve body 84 and a tee 132. In one application, regulating device 138 is a flow restriction, creating a differential pressure with fluid 14 that is to be regulated by control device 300. That is, fluid pressure upstream of regulating device 138 from tee 132 and flowing through passageway 134 is greater than the fluid pressure at inlet 98. Regulating device 138 may also be laminar, venturi, orifice or porous element types, or include other suitable constructions.

By virtue of the greater fluid pressure flowing through passageway 134 than through inlet 98, diaphragm 112, piston 128 and seat 130 will collectively be urged to move to the closed position. Bellows 116 and resilient member 122 provide opposed forces to balance control device 300 at a desired pressure differential.

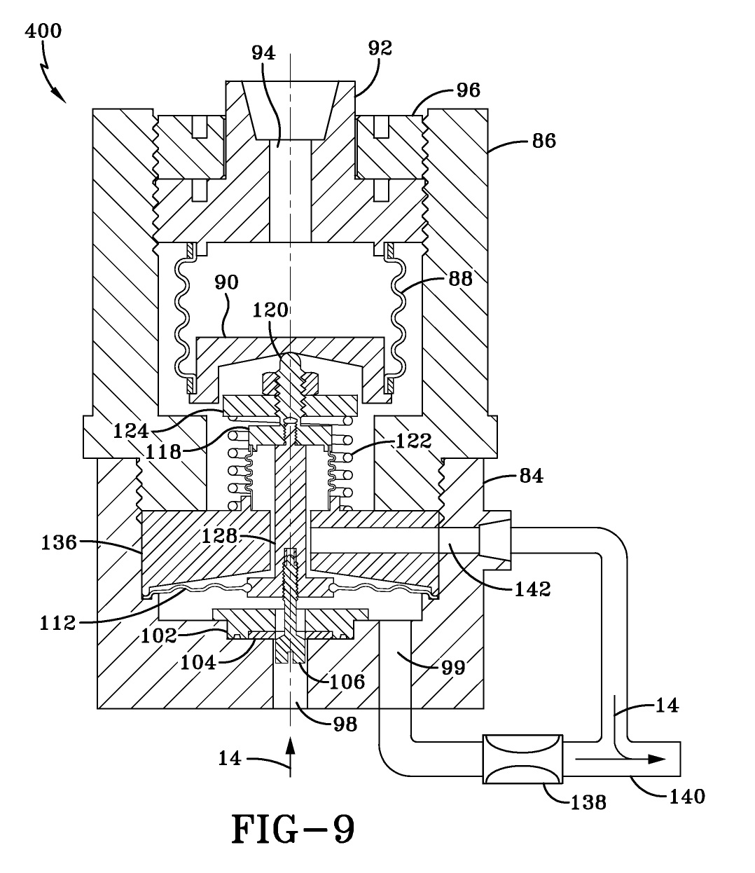

FIG. 9 shows a construction of control device 400 that is similar to control device 200 except as discussed. One difference is a passageway 142 formed in a collet 136, otherwise similar to collet 136 of FIG. 8. A regulating device 138 is disposed downstream of control device 400 between outlet 99 of valve body 84 and a tee 140. In one application, regulating device 138 is a flow restriction, creating a differential pressure with fluid 14 that is to be regulated by control device 400. That is, fluid 14 flowing through passageway 142 toward tee 140 and positioned downstream of regulating device 138 has a fluid pressure that is less than the fluid pressure at outlet 99.

By virtue of the lesser fluid pressure flowing through passageway 142 than through outlet 99, diaphragm 112, piston 128 and seat 130 will collectively be urged to move to the closed position. Bellows 116 and resilient member 122 provide opposed forces to balance control device 400 at a desired pressure differential.

Control device arrangements, such as those in FIGS. 6A and 6B, can make use of fluid pressure in each of bellows 88 and bellows 116 to minimize the effect typically referred to as a “droop curve”. An exemplary droop curve for a conventional control device construction is shown in FIG. 10. FIG. 10 is a graphical representation of outlet pressure (psig) (y-axis) versus flow rate (slpm; standard litres per minute)(x-axis) for a given inlet pressure. The droop curve is most pronounced for an inlet pressure of 200 psig in FIG. 10. That is, the slope of the curve corresponding to an inlet pressure of 200 psig is negative and contains the steepest negative slope. The basis for the “droop” is the increasing rate of reduction of outlet pressure with respect to a corresponding range of increasing flow rates. Conventional control devices use spring forces to regulate flow of a regulated fluid. In order to increase flow, the valve must be moved further away from the valve closed position. As the spring further elongates, the amount of force the spring is capable of exerting decreases. The resulting decrease in the ability of the spring to further elongate to effect increased flow is referred to as “droop”. Since the control device arrangements of the present invention primarily make use of pressurized fluids, not springs, to effect valve control, the resulting curves show a reduction in “droop”. That is, bellows 88, 116 are configured to reduce a magnitude of a negative slope of a droop curve associated with a predetermined fluid pressure of the regulated fluid at the inlet.

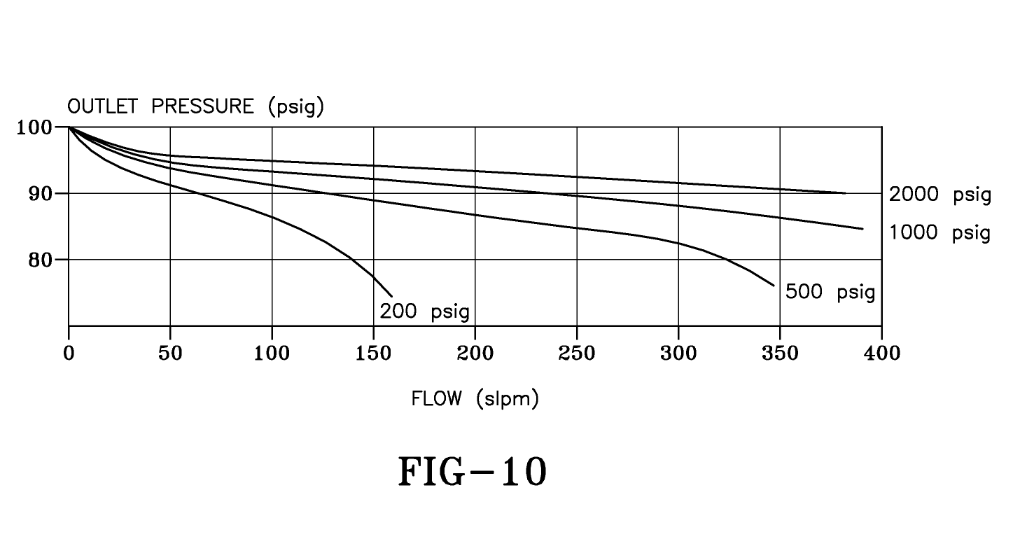

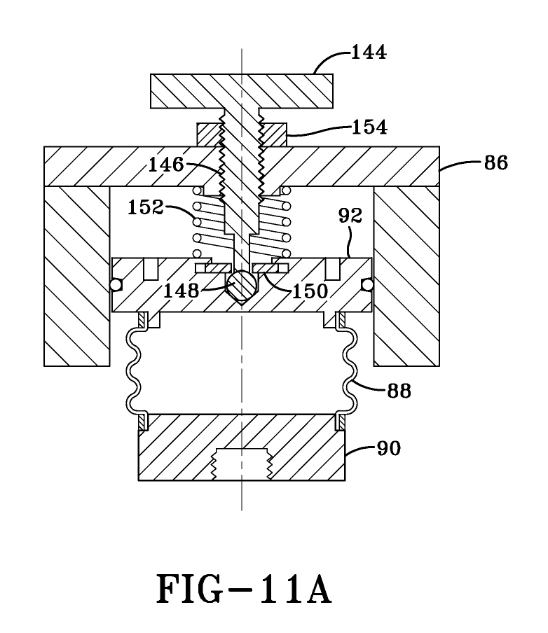

FIGS. 11A and 11B show a construction of control device 500 that is similar to control device 200 except as discussed. Instead of using pressurized fluid as an adjustment feature, control device 500 includes adjustment feature 144 in the form of an adjustable threaded connection. Adjustment feature 144 includes a threaded shaft 146, such as fine pitch threads, permitting fine-tune adjustments by virtue of threaded engagement with valve housing 86. Threaded shaft 146 extends to an enlarged end 148, such as a sphere, that is insertable into a recess 145 formed in base 92. A retainer 150, such as a snap-ring, is configured to be placed in recess 145 to retain end 148 inside of recess 145. An anti-backlash device 152, such as a spring, is compressively positioned between base 92 and valve housing 86. Anti-backlash device 152, when maintained in compression throughout the range of adjustment of threaded shaft 146, is configured to provide a retention force to base 92 and valve housing 86 and tending to maintain threaded shaft 146 in tension, and further maintaining end 148 in contact with anti-backlash device 152. By maintaining threaded shaft 146 in tension and end 148 in contact with anti-backlash device 152, anti-backlash device 152 eliminates relative movement between base 92 and threaded shaft 146 that could otherwise occur, especially in instances where the rotation direction of threaded shaft 146 is reversed during operation. Upon reaching a satisfactory adjustment setting of adjustment feature 144, an optional locking device 152, such as a locknut, may be employed to maintain threaded shaft 146 in a fixed position.

FIG. 11B shows an application of control device 500 including an adjustment feature in the form of a stepper motor 156. In one embodiment, stepper motor 156 may be a linear stepper motor. Stepper motor 156 can be configured to automatically rotate threaded shaft 146 to regulate the position of base 92 as previously discussed. FIG. 11B, which is similar to control device 400 (FIG. 9), includes fluid communication between bellows 88 and bellows 116. A passageway 158 formed in piston 128 and piston 90 permits fluid 14 entering valve body 84 through passageway 142 to flow into fluid communication with bellows 116. Depending how bellows 88 and bellows 116 are sized, their effects could cancel each other for a predetermined outlet pressure associated with fluid between tee 140 and passageway 142.

It is to be understood that bellows 88 and bellows 116 are selectably replaceable, providing adjustability not previously obtainable in known control device constructions. That is, by selectably providing differently configured bellows, the operating range of control device can be significantly expanded, where previously, specially configured control devices would need to be installed. Further yet, by virtue of adjustment features previously discussed, tolerances associated with the assembly of different bellows constructions could be disregarded by selectable adjustment of the adjustment features, without requiring disassembly of the control device.

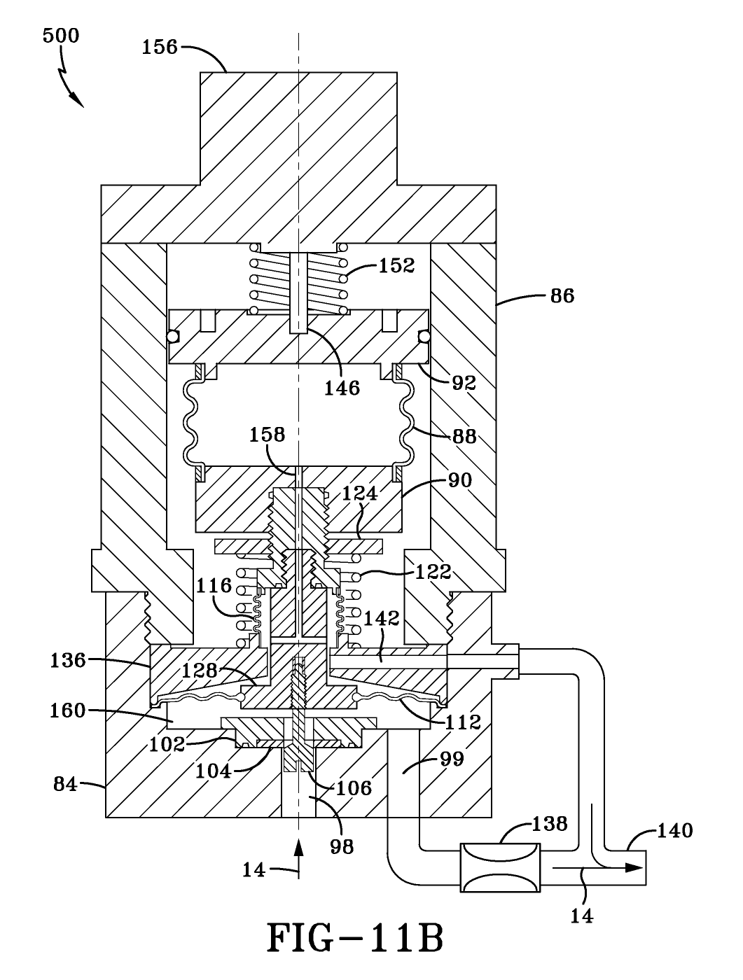

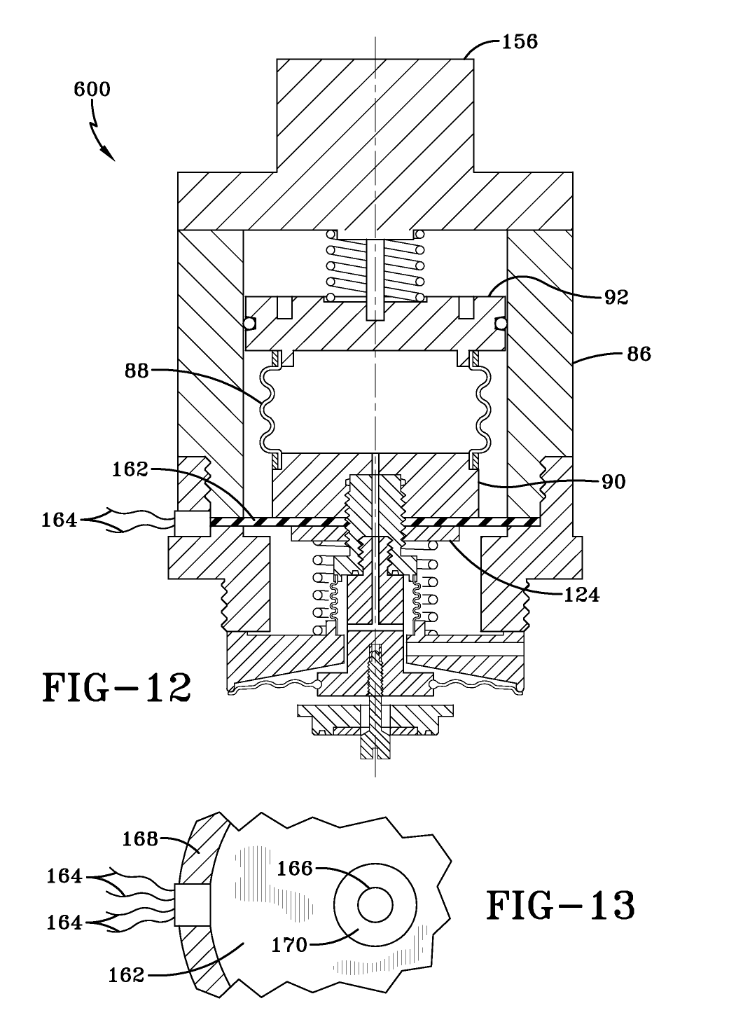

FIG. 12 shows a novel use of a sensor for use with a control device. Control device 600, which is similar to control device 500, includes a sensor 162, such as a strain sensor. Sensor 162 can be a piezo film, which senses strain based on a voltage produced during operation. In one embodiment, the film is composed of polyvinyl fluorocarbon (PVDP) material, although other suitable materials may also be used. As shown, sensor 162 may be secured to one of bellows 88, 116 or to an interface between bellows 88, 116, such as between piston 90 and adjustment member 124. Voltage readings may be obtained from leads 164 electrically connected to sensor 162 and extending away from sensor 162. As shown in FIG. 13, sensor 162 includes insulating regions 168, 170 corresponding to portions of sensor 162 that may be in abutting contact with control device components. Sensor 162 includes an opening 166 to permit sensor 162 to slide over mating components, such as the connection between piston 90 and adjustment member 124. That is, sensor 162 is not a diaphragm.

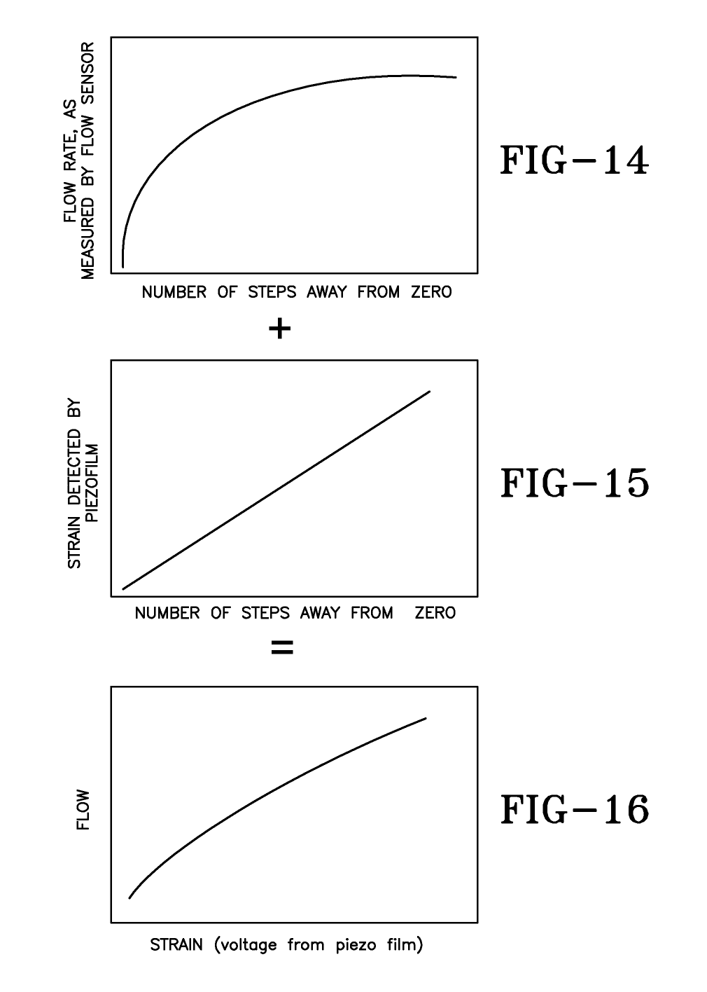

FIGS. 14-16 show graphical representations of flow rate as sensed by a flow sensor (FIG. 14) compared to that from a strain piezo-film to obtain improved response for flow rate for a fluid system of the present disclosure. FIG. 14 shows flow rate versus a number of “steps” of a stepper motor. FIG. 15 shows strain of film sensor 162 versus a number of “steps” of a stepper motor. FIG. 16 shows a derivation of FIGS. 14 and 15 in which there is a correlation between flow rate and strain of film sensor 162. In other words, sensor 162 can be used to quickly help calibrate a stepper motor used to determine predetermined positions, such as from the control system miscounting steps of the stepper motor. In addition, by sensing an amount of strain of sensor 162, the response of control system may be improved, permitting the control system to quickly move from P of PID to I or D. Additionally, use of sensor 162 can permit recalibration of control system to confirm true position of bellows.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A fluid control system for regulating a fluid comprising:
a body having a first inlet and a first outlet in fluid communication;
a control device positionable between the first inlet and the first outlet comprising:
a first bellows;
a second bellows;
a first resilient member;
a diaphragm;
a valve; and
wherein the diaphragm and the valve is each in selectable fluid communication with the first inlet and the first outlet, the valve movable between a closed position and an open position in which the open position permitting fluid communication between the first inlet and the first outlet; and
wherein the diaphragm is in fluid communication with the second bellows; and
an adjustment feature associated with adjusting a force applied by at least one of the first bellows and the second bellows, wherein adjustment of the adjustment feature not requiring disassembly of the control device; and
wherein in response to a predetermined fluid force applied against the diaphragm by the regulated fluid flowing from the first inlet toward the first outlet, the first bellows, the second bellows and the first resilient member applying a combination of opposed forces to selectably move the valve toward a position for regulating the regulated fluid.

2. The fluid control system of claim 1 wherein the system is configured for use in an intrinsic safety environment.

3. The fluid control system of claim 1 further comprising a sensor positioned between a second inlet and a second outlet to sense a fluid parameter of the regulated fluid, wherein both the first inlet and the second inlet and the first outlet and the second outlet can be the same, or at least one of the first inlet and the second inlet or the first outlet and the second outlet can be remotely located from each other.

4. The fluid control system of claim 3 wherein the sensor is taken from the group consisting of: a flow sensor, a mass sensor, a chemical concentration sensor, a temperature sensor and a pressure sensor.

5. The fluid control system of claim 1 wherein the adjustment feature is taken from the group consisting of an adjustable threaded connection and a pressurized fluid source.

6. The fluid control system of claim 5 wherein the threaded connection is manually adjustable.

7. The fluid control system of claim 5 wherein the threaded connection is adjustable by a stepper motor.

8. The fluid control system of claim 1 wherein the first bellows and the second bellows are selectably replaceable.

9. The fluid control system of claim 1 wherein the first bellows and the second bellows are configured to reduce a magnitude of a negative slope of a droop curve associated with a predetermined fluid pressure of the regulated fluid at the first inlet.

10. The fluid control system of claim 1 further comprising a sensor positioned along an interface between the first bellows and the second bellows, the sensor capable of detecting an amount of movement of the interface away from a predetermined position.

11. The fluid control system of claim 10 wherein the sensor is a piezo-film sensor.

12. The fluid control system of claim 11 wherein the piezo-film sensor defines an annulus.

13. The fluid control system of claim 3 wherein the system is configured for use in an intrinsic safety environment.

14. The fluid control system of claim 1 further comprising a regulating device positioned between the first inlet and a first outlet to regulate a fluid parameter of the regulated fluid.

15. A method for regulating a fluid flowing from an inlet toward an outlet in a fluid control system, the steps comprising:
providing a control device positionable between the inlet and the outlet comprising:
a first bellows;
a second bellows;
a first resilient member;
a diaphragm;
a valve; and
wherein the diaphragm and the valve is each in selectable fluid communication with the first inlet and the first outlet, the valve movable between a closed position and an open position in which the open position permitting fluid communication between the first inlet and the first outlet; and
wherein the diaphragm is in fluid communication with the second bellows; and
adjusting an adjustment feature associated with adjusting a force applied by at least one of the first bellows and the second bellows, wherein adjustment of the adjustment feature not requiring disassembly of the control device; and
positioning the first bellows, the second bellows and the first resilient member so as to apply a combination of opposed forces to selectably move the valve toward a position for regulating the fluid in response to the fluid applying a predetermined fluid force against the diaphragm.

16. The method of claim 15 wherein the adjustment feature is taken from the group consisting of an adjustable threaded connection and a pressurized fluid source.

17. The method of claim 16 wherein the adjusting step includes manually adjusting an adjustable threaded connection.

18. The method of claim 16 wherein the adjusting step includes a stepper motor adjusting an adjustable threaded connection.

19. The method of claim 15, further including an additional step of configuring the system for use in an intrinsic safety environment.

20. A fluid control system for regulating a fluid comprising:
a body having an inlet and an outlet in fluid communication;
a control device disposed between the inlet and the outlet comprising:
a first bellows;
a second bellows;
a first resilient member;
a diaphragm;
a valve; and
wherein the diaphragm and the valve is each in selectable fluid communication with the first inlet and the first outlet, the valve movable between a closed position and an open position in which the open position permitting fluid communication between the first inlet and the first outlet; and
wherein the diaphragm is in fluid communication with the second bellows; and
an adjustment feature associated with adjusting a force applied by at least one of the first bellows and the second bellows, the adjustment feature taken from the group consisting of an adjustable threaded connection and a pressurized fluid source, wherein adjustment of the adjustment feature not requiring disassembly of the control device; and
wherein in response to a predetermined fluid force applied against the diaphragm by the regulated fluid and flowing from the inlet toward the outlet, the first bellows, the second bellows and the first resilient member applying a combination of opposed forces to selectably move the valve toward a position for regulating the regulated fluid.

21. The fluid control system of claim 20 wherein the system is configured for use in an intrinsic safety environment.

22. The fluid control system of claim 1 wherein the first bellows and the second bellows are substantially aligned.

23. The fluid control system of claim 1 wherein the combination of opposed forces are applied in opposed directions.
